(19) United States
(12) Patent Application Publication
(10) Pub. No.: US 2005/0042042 A1
(43) Pub. Date: Feb. 24, 2005

(54) Movement modification of feed streams in separation apparatus

(75) Inventor: Neville Clarke, Berwick (AU)

Correspondence Address: MICHAEL BEST & FRIEDRICH, LLP, 100 E WISCONSIN AVENUE, MILWAUKEE, WI, 53202, US

(73) Assignee: Neville Clarke, Berwick Vic (AU)

(21) Appl. No.: 10/872,619

(22) Filed: Jun. 21, 2004

(30) Foreign Application Priority Data
Jul. 16, 2003 (AU) 2003903679
Jan. 14, 2004 (AU) 2004900162

(51) Int. Cl. B65G 53/40

(52) U.S. Cl. 406/108

(57) ABSTRACT

A swirl generator is described for use in a cyclonic evaporator to receive fluid axially and discharge the fluid tangentially through one or more outlets. The swirl generator is moveable so as to be separated from the evaporation tube so as to facilitate clean in place practices overcoming the need to remove the evaporation tube which can in some instances be up to twelve meters long. Movement of the head allows relatively fast and efficient cleaning of the cyclonic evaporator.

The present invention relates generally to cyclonic evaporators. In particular, the present invention relates to improvements in the upper part of the cyclonic evaporator which is the motion imparting part of the cyclonic evaporator, particularly to the head or inline swirl generator or distribution head of the cyclonic evaporator for imparting or contributing to imparting a swirling movement to the feed stream introduced into the cyclonic evaporator. Even more particularly, the present invention relates to passage of the feed material through the evaporator tube in a swirling motion, particularly to adjust the residence time of the feed material in the top portion or region of the tube where it undergoes swirling movement prior to forming a falling film part way long the length of the tube. Even more particularly, the present invention relates to a swirl generator having a motion modifying element or similar which is responsible for or contributes to the formation of the swirling movement of the feed material in the top of the evaporator tube.

The present invention finds particular application as an improvement to the upper portion of a cyclone evaporator, particularly the head of hydrocyclonic evaporators for introducing feed material into an evaporator by forming or assisting in forming the material into swirling motion, such as for example, a helical flow, a spiral flow, or the like around the internal wall of the evaporator in a more or less substantially uniform manner so that the film of the feed material being formed in the evaporator or evaporator tubes is in more intimate contact with the wall of the tube, before, during and prior to vaporising the swirling feed stream into one or more of the components of the feed stream, thereby separating at least one of the components from the feed material. The improvement comprises having a swirl generator with spaced apart outlets or ports for distributing the discharge from the generator into the evaporator tube or tubes, particularly associated with a motion modifying element, preferably located near to the outlets, that are at least partly responsible for the swirling movement.

Although the present invention will be described with particular reference to one form of a swirl generator having at least one outlet and at least one form of a motion modifying element, it is to be noted that the scope of the present invention is not restricted to the described embodiment, but rather the scope of the present invention is more extensive so as to include other forms and arrangements of the swirl generator, of the separation device(s) and of the components for imparting a swirling motion to the feed material prior to entry into the evaporator, including different forms and arrangements of the motion modifying elements or combination of elements and to devices other than evaporators, such as for example, in other separation devices, mixers and the like whether using heat or cooling to separate the components of the feed stream.

International patent application no. PCT/AU99/00836 describes a cyclonic evaporator which is a single apparatus that is a combination of a motion imparting device, which is referred to as the head of the evaporator or a swirl generator, and an evaporator body comprising one or more evaporator tubes arranged within the one apparatus. The tubes of the apparatus are heated or cooled to vaporise or condense material located within the tubes so as to separate components of the feed material that is introduced into the separator. In some forms these evaporators have a large number of tubes arranged in a bundle within a single housing in which each tube is provided with a head or similar distribution device or one distribution device is used to feed a plurality of different tubes. Such a combined device is referred to as a cyclonic evaporator, since the incoming feed material after passing through the swirl generator or hydrocyclone head has a swirling movement on entering the cyclonic evaporator to enhance the separation characteristics in the evaporator tubes in which the feed material is separated into at least two different components. One example of the head is known as an in-line swirl generator (ISG) which receives the feed material axially and discharges the feed material in a swirling motion such as for example, in a helical flow, a spiral flow, a more or less spiral-like flow that is tangential to the axis of the apparatus, or the like.

Whilst cyclonic evaporators have increased efficiency over other types of evaporators, particularly non-cyclonic evaporators, such as overflow weir evaporators or the like, and are effective in many applications for separating materials, particularly liquid materials from each other, owing to the swirling motion imparted by the head or swirl generator, which aids the vaporisation of materials, it has been discovered that the performance of cyclonic evaporators can be improved even further by modifying the head of the evaporator to achieve better separation of components, particularly by providing a more uniform film coverage of the internal walls of the evaporator tubes, and/or by providing more intimate contact between the moving thin film of feed material and the internal wall of the evaporator tube as the film of feed material flows downwardly along the walls of the evaporator tube. The present invention relates to such a modified head.

One disadvantage of existing hydrocyclone evaporators is that the stream of feed material emerging from the head of the evaporator, such as the inline swirl generator for imparting swirling motion to the feed material prior to entry to the evaporator body itself, is that the stream of feed material is generally uneven and not usually uniformly distributed over the entire inner surface of the evaporator tubes and further has a tendency to form into a bunched stream, such as for example, having a core with the appearance of platted rope or similar, the so-called “rope” effect. The formation of the “rope” effect hinders the uniform transference of heat over and through the walls of the evaporator tubes so that there is uneven heating and vaporisation of the stream of feed material in the evaporator tube or tubes, since in some places the stream is thick whereas in others it is thin. If the stream is thick the available heat transferred to and through the film may be insufficient to heat the stream to evaporate the components to separate them from one another, whereas if the film is too thin, too much heat is transferred which could result in burning, charring, or the like of the feed material or its components which in turn can lead to deposits of charred material building up on the side wall of the evaporator tube either clogging or blocking the tube or creating a hot spot. This same defect also applies to uneven thicknesses of film. Accordingly, the uniform transference of heat is impeded by not having a substantially uniform film. Thus, there is a need for a more uniform film of feed material being produced in the evaporator tube or tubes.

Cyclonic evaporators are often used in the food industry. Periodically, the inside walls of the evaporator tubes require cleaning. In some instances, the evaporator tubes can be cleaned in situ. Techniques allowing in situ cleaning are often referred to as “clean in place” techniques or methods, which mean that the evaporator and tubes do not have to be disassembled in order to be cleaned, but rather at the relevant time the tubes can be flushed or otherwise cleaned with a suitable cleaning preparation by merely flushing or rinsing the tubes with the cleaning preparation, thereby obviating the need to disassemble the evaporator and remove the tubes. However, in some applications, particularly in the food industry, and more particularly with processes involving food materials in the form of food particles or similar, food particle residue can build up on the walls of the evaporator tube, particularly if there are small cracks, ledges, crevices, crannies or the like in or on the inside walls of the evaporator. Clean in place techniques involving flushing or rinsing of the tubes does not satisfactorily remove such particles. Thus, there is a need to provide a structure for the swirl generator and/or conditions within the evaporator that promotes clean in place techniques for cleaning the evaporator tubes of cyclonic evaporators.

Also, there is a need to have as smooth a surface as possible on the inside surfaces of the evaporator tubes to reduce or minimise the amount of residue that can be deposited in or on the surface irregularities on or in the inside walls of the evaporator.

Another disadvantage of the currently available cyclone is that the evaporator tubes need to be of a considerable length in order to heat the material sufficiently to separate the components. Having tubes in excess of about 10 meter and up to about 18 to 20 meter results in the evaporator installations being of a large size and being costly to manufacture, install, operate and maintain. Therefore there is a need to reduce the length of the evaporator tubes so as to reduce costs and to reduce the size of the installation together with reducing the running costs of operating the installation.

Another disadvantage of existing evaporators, including cyclonic evaporators, is that the head or distributor imparting the swirling movement to the feed material is fixedly attached to the evaporator tube making the evaporator almost impossible to clean in situ, and difficult to clean without disassembly of the evaporator and even then the head and tube being a single unit required specialised cleaning. Thus, there is a need for an assembly, particularly a swirl generator which is easier to clean, particularly to clean-in-place by the head being removable or detachable from the evaporator tube obviating the used to remove the tubes.

Another disadvantage of the evaporators is that as the head was fixed to the evaporator tube, only a single type of head could be used with the one tube. If it was required to replace the head with a different type of head, such as for example to treat a different type of feed material, the entire assembly of head and tube required replacing which was expensive and time consuming. Thus, there is a need for an assembly having an interchangeable head that can be quickly and easily replaced whilst retaining the same tube so that the assembly can be used to separate a greater variety of materials.

Accordingly, it is an aim of the present invention to improve the performance of cyclonic evaporators, and to prevent or reduce the build-up of material in the evaporator by providing a modified head or modified motion imparting device of a cyclonic evaporator.

Another aim of the present invention is to provide “a-clean-in-place” head and tube arrangement in which the head is easily removable, is loosely mounted in the top of the tube allowing movement of material past the head, and/or is easily interchangeable so that heads of different sizes, shapes and/or styles can be used with the one tube, typically interchangeably without hexals. Another aim of the present invention is to provide a “floating” head that can be rotated either in use or periodically whilst cleaning the tube and other parts of the evaporation installation i.e. the head can be rotated in the tube to different positions. Another aim of the present invention is to provide a self draining head or self cleaning head in which fluid is allowed to drain away from the head, typically almost automatically as a matter of course when supply of fluid is interrupted, terminated or the like. Another aim of the present invention is to provide a swirl generator or similar having a motion modifying element, particularly for being responsible, at least partially, for producing the swirling movement.

According to the present invention there is provided a swirl generator characterised in that the generator comprises an open end located at or towards one end of the generator for receiving fluid therethrough, a side wall portion and a closed end located at or towards another end of the generator, said side wall portion extending between the open end and the closed end, wherein the open end is part of an inlet for admitting fluid into the generator and that at least one outlet is provided in the side wall and/or closed end of the generator for discharging fluid from the generator and tube wall in a swirling motion wherein the generator is provided with a motion modifying element for influencing the flow of material discharged from the outlet.

Typically, the feed material is an aqueous-based waste material or an organic solvent-based waste material. More typically, the feed material is an alcohol-containing aqueous waste material in which the alcohol is typically methanol, ethanol, propanol or the like. Typically, the feed material is an aqueous glycol solution, glycerine solution or the like. More typically, the evaporator incorporating the device or devices of the present invention is used in the chemical industry, food and beverage industries, diary industries, pharmaceutical industry, oil and petroleum industry or the like.

More typically, the waste material is a fruit juice syrup containing water residues in which it is required to separate the water from the fruit juice concentrate. More typically, the waste material is a mixture of organic materials, such as solvents and other flammable material, for example glycols or similar. Even more typically, the waste material is a water and milk solids mixture resulting from processes and treatments within the dairy industry and processes used therein. Even more typically, the material being treated emanate from the food and/or beverage industries, the dairy industry or the like, such as for example feed materials requiring removal of water or the aqueous phase from milk, milk solids or other milk products. Typically, the treatments include dehydrating materials, particularly solids materials such as fats, greases or the like. One particular application of the evaporator is in treating milk products so as to separate the lactose from skim milk or the like. In this application, heads of different sizes, styles and shapes are required for treating the lactose than are required for treating the skim milk. The present invention provides for interchangeability of the heads in these applications.

Typically, the treatments include the dehydration of aqueous solutions of glycols and/or glycerines in purification processes of these materials.

Typically, the head of the cyclonic evaporator is a motion imparting device, typically a swirl generator, more typically a in-line swirl generator. More typically, the hydrocyclone head unit is a distributor head or the like, particularly a swirl head distributor. Even more typically, the or each swirl generator has one, two, three, four or more conduits, bores, ports, orifices, apertures, grooves or the like in the head or body of the generator. More typically, the conduits etc. form outlets of the head for discharging feed material. More typically, the conduits are straight, curved, tapered, spiral or helical conduits, or the like or are provided with nozzles or the like. More typically, the swirl generator is a tangential flow swirl generator, even more typically, the inlet of the swirl generator head is located axially to receive in-coming feed material substantially axially along the central axis of the apparatus. Typically, the inlet is a well, weir, cavity, chamber or the like located internally within the body and having an opening in the top or upper surface of the head. More typically, the well is provided with the outlets, more typically, the well is provided with inlets of the outlets. More typically, the outlets are the conduits etc. Even more typically, the conduits etc are arranged tangentially to the wall of the well. The inlets of the outlets are arranged within the well tangentially to discharge material tangentially or substantially tangentially to the central axis of the circular cyclone body of the evaporation apparatus in which the head is located. Typically, the outlet of the outlets discharge material towards the wall of the evaporator tube.

Typically, the tangential exit of the conduit, etc. is located in the wall of the swirl generator, typically, on the outside of the side wall of the generator so that feed material discharged from the end of the conduits or the like can have a swirling motion imparted to it. More typically, the outlet or outlets are located at or towards the lower end surface of the head unit, typically near to the lower corner of the head unit where the side wall and lower surface in use meet each other.

Typically, the swirling movement is imparted to the feed material being discharged from the outlets by contact against the wall of the tube, which is to say that a directional spurt of the material comes out of the outlet and hits the wall to make the swirling motion. More typically, the direction of discharge of the outlets is non-radial, so that the direction of flow is inclined to the radial direction.

Typically, the conduits, outlets etc. are located at spaced apart locations around the parameter of the head, more typically at regularly spaced locations or at equidistant locations from one another around the side wall or closed end of the head.

Typically, the motion imparting device is an inline swirl generator. More preferably, the velocity of the components of the waste material is increased by passage to and/or through the generator. Typically, the velocity of the material being discharged from the generator is determined at least partially by the size of the openings and/or conduits located in the head device, and/or by the internal diameter of the head unit and/or by the external diameter of the head unit. Typically, the generator has variable size, diameter or shape conduits, outlets or the like.

Typically, there is a swirl generator for each tube. Alternatively, there are two or more, preferably multiple tubes for each head. Typically, there are one or two or more heads, including two or more multiple heads per evaporator. More typically, each head or distributor has a single large conduit or multiple conduits or a plurality of smaller sized conduits. Typically the bore size of the conduit is from about 0.5 mm to about 10 mm, preferably from about 0.1 to 6 mm, more preferably about 2.0 mm to 5 mm, most preferably about 3.0 to 40 mm, and about 3.5 to 3.6 mm.

Typically, the cyclonic evaporator of the present invention operates in a non flooded mode or a not fully flooded mode or in an unflooded mode in which the thin film of feed material discharged from the head is in contact with the evaporator tube or tubes.

Typically, the head or generator is provided with an insert, typically an insert in which the head is received and the insert is received in the top of the tube. More typically, the hydrocyclone head is a combination of a head holder and a head body. More typically, the holder and head are tapered, preferably correspondingly tapered. Even more typically, the taper merges seamlessly with the top of the evaporator tube. More typically, the inserts are replaceable or interchangeable.

Typically, the swirl generator is provided with a motion modifying element for modifying the flow or discharge of feed material from the outlet, particularly to assist in providing a uniform film on the evaporator walls. More typically, the motion modifying element is a collar, bandage, weir wall, flange, ring, boss, upstand, projection, guide, surface, rebate, groove or the like. More typically, the collar ring etc. is located around the outside of the body. More typically, the collar is continuous, discontinuous, or there may be more than one collar or the like. More typically, the collar or the like does not touch the inner wall of the tube, more typically, does not touch the wall at any time during operation. More typically, there is a space, gap, cavity, clearance, or the like located between the motion modifying element and the inner wall of the tube.

Typically, the collar is located in the region or vicinity of the closed end of the head. More typically, the collar is a lower flange, more typically a lower flange located around the lower edge of the side wall of the generator, or around the edge of the closed base of the generator. More typically, the space, gap, clearance between the collar and tube wall is fully flooded between flange and wall instantaneously in operation to assist in producing a swirling motion as the fluid is discharged from the outlet against the wall.

Typically, the length of the or each evaporator tube can be up to 10-12 meter in length or the like. More typically, the tube or tubes can be up to 8 m in length, preferably the length is from about ½ meter to 6 m, more preferably from about 2 to 6 m.

Typically, the swirling motion is produced by a combination of the motion modifying element and the inner wall of the tube in that the impact of the feed stream on the wall forms a more or less uniform thickness film.

Typically, the motion imparted to the swirling feed material exiting from the distribution head by the distribution head or swirl generator is a combination of different motions. More typically, the initial swirling motion gradually transits into a falling motion which is substantially axial to the lengthwise extending direction of the tube. Even more typically, the film of feed material is in contact with the inner wall of the evaporator tube. Thus, the material exiting the outlet of the swirl generator is in the form of a swirling motion which gradually changes into a linear motion of a falling film against the side walls of the evaporator tube.

Typically, the swirling motion imparts shear to the feed material. More typically, the amount of shear can be controllably adjusted by adjusting the conduit size and number of conduits in the head or the like.

Typically, the velocity and direction of the swirling motion is such that the residence time of the feed material, particularly in the initial swirling movement is sufficient to allow efficient separation of at least one of the components in the feed material from the other components. More typically, the inside of the tube is substantially smooth to promote uniform spread of the film over the surface of the wall. Typically, the diameter of the evaporator tubes is from about 5 mm to 100 mm, preferably from about 10 to 80 mm, more preferably from about 20 to 60 mm, most preferably from about 45 to 65 mm.

Typically, the head of the present invention is a floating head which sits in a seat located at or towards the top of the evaporator tube. More typically, the head is rotatable within the seat. In some embodiments, the head can be rotated substantially continuously whereas in other embodiments the head can be rotated intermittently or periodically, whilst in other embodiments the head can be rotated randomly. In some embodiments the action of the material through the head causes the head to rotate under the influence of the material moving. Even more typically, the head can be displaced away from the seat by back washing, flooding or flushing the tube in order to clean the tube. Displacing the head allows clearance between the tube and the head to be increased in order to facilitate cleaning of the tube and head by allowing cleaning preparations to pass through and between the head and tube to dislodge any particles that may have accumulated around the head and tube including the seat of the tube. Even more typically, the head is a movable head that is displaced, typically, axially movable, more typically the head is a “pop-up” head that “pops up” under the action of a cleaning solution being back washed or flooded through the tube.

Typically, the head is a self-draining head in which fluid is allowed to drain away from the head through the tube because of the loose fit of the head in the tube. More typically, the discharge ports of the head act as drainage ports or the like through which the fluid drains away.

Typically, the head is interchangeable. More typically, the interchangeable head or heads can be of the same size with different arrangements, numbers or patterns of discharge ports or outlets or the heads can be of different sizes with different arrangements, numbers or patterns of discharge ports or outlets. Alternatively, the heads can be of different sizes with the same sized ports or outlets. It is to be noted that different arrangements of discharge ports produce different configurations or patterns of flow within the evaporator tube, and hence can be used for different purposes with different materials.

Typically, the arrangement of the present invention results in improved thermal efficiency of the product being swirled axially along the walls of the tube in a downwards helical flow or similar flow path or pattern. It is the configuration of the swirling movement combined with the contact of the product against the interior wall of the tube which enhances the transfer of heat through and into the tube and/or product. By altering the movement of the product different heat transfer coefficients can be attained. More typically, there is an increase in the U factor or U value of the heat transfer. The U value is a measure corresponding to the efficiency of heat transfer or is a measure of the heat transfer coefficient. More typically, the U value is in the range of from about 1500 to 20,000, preferably up to about 15,000, and more preferably in the range of from about 2000 to 10,000, most preferably in the range from about 2500 to 8000, and in the range from about 3000 to 6000, preferably in the range from about 3000 to 4000.

Typically, the head of the present invention can accommodate considerable variations of flow through tubes and can be operated over a wide range of U values, i.e. the head has variable turn down ratios.

The present invention will now be described by way of non-limiting example with reference to the accompanying drawings, in which:

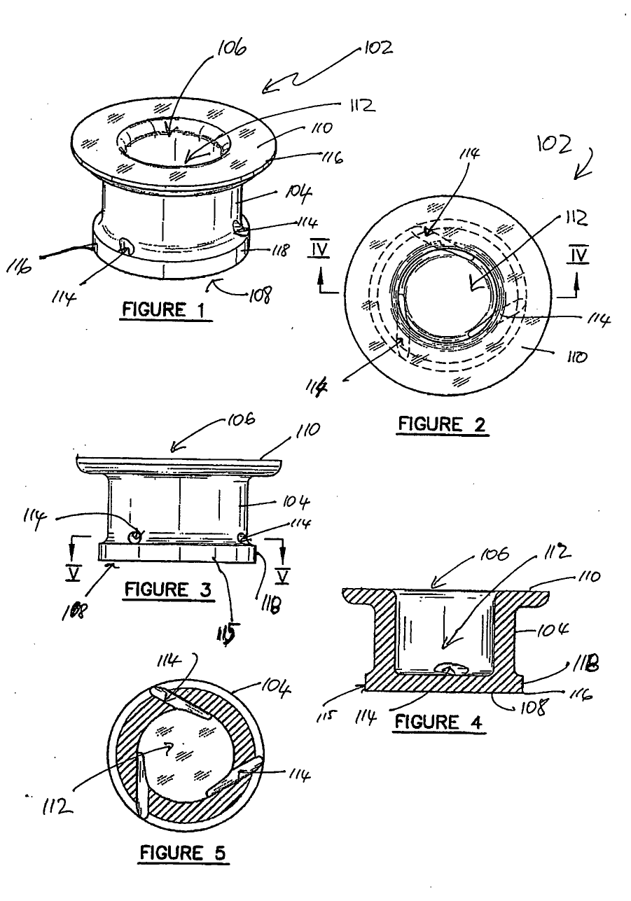

FIG. 1 is a perspective view of one form of the swirl generator of the present invention.

FIG. 2 is a top plan view of the swirl generator of FIG. 1 showing the discharge ports or outlets in phantom.

FIG. 3 is a side elevation view of the swirl generator of FIG. 1.

FIG. 4 is an axial cross sectional view of the swirl generator of FIG. 1 taken along the line IV-IV of FIG. 2.

FIG. 5 is a transverse cross sectional view of the swirl generator of FIG. 1 taken along the line V-V of FIG. 3.

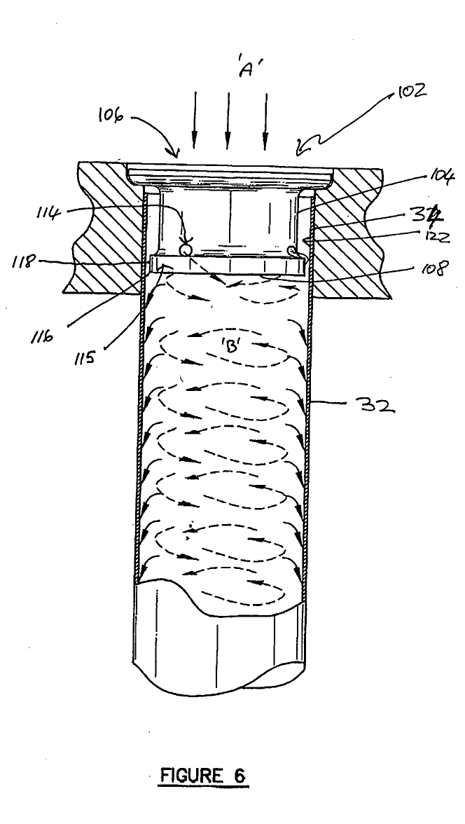

FIG. 6 is an axial cross section of one form of an evaporator tube of a cyclonic evaporator having the swirl generator of the present invention showing the swirling movement of the feed material after exiting from the swirl generator.

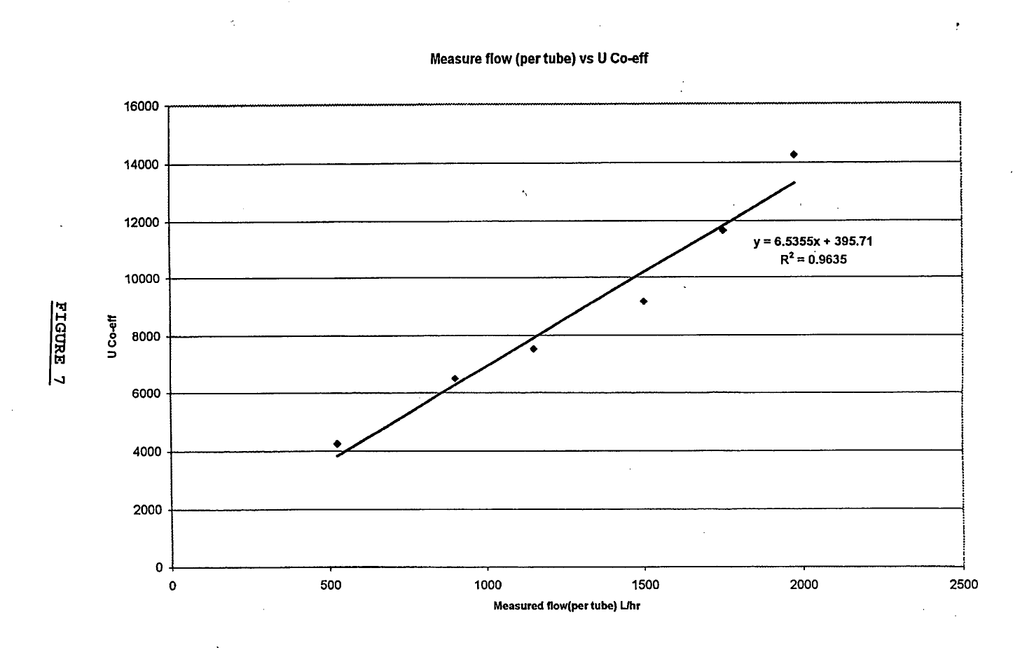

FIG. 7 is a plot of the heat transference value (U coefficient) as a function of measured flow of fluid through an evaporator tube in litre per hour using one form the swirl generator of the present invention in one form of cyclonic evaporator.

One embodiment of the head subassembly, known as the swirl generator, of the present invention is shown in FIGS. 1 to 6. This form of the head, generally denoted as 102, is a distributor head, typically a swirl generator, more typically an in-line swirl generator sometimes known as a Swirl Distribution Head (SDH), that contributes, along with the wall of the evaporator tube to the formation of a substantially uniform thin film being produced at or towards the top of the evaporator tube 32. Head 102 is a replaceable or interchangeable head and may be made from any suitable material, such as for example stainless steel for use in the food and beverage industry, particularly the dairy industry to separate solid milk particles from dairy products. Head 102 is formed so as to be received within the top 34 of evaporator tube 32 which is provided with a rebate or seat (not shown) for receiving the head 102 therein or similar arrangement. It is to be noted that the fit can be a snug fit with fine tolerances or the fit can be reasonably loose allowing quick and easy removal of head 102 from the top 34 of evaporator tube 32 when cleaning of the apparatus is required or when the head is to be exchanged or replaced. Also, the fit is such that the head can rotate within the top 34 of tube 32 or seat of the tube to assist in providing an even distribution of material into the top of the evaporator tube or the like on being discharged from head 102.

In one form head 102 is formed as a hollow cylindrical body having side walls 104, open top surface 106 provided with an opening and closed base 108 in which the walls 104 extend between open top 106 and closed base 108. A circumferential flange 110 is located around the circular edge of open top surface 106 for being received in the rebated groove located at or towards the top of evaporator tube 32 or in the substrate surrounding the top 34 of tube 32. In one form the upper edge of flange 110 is straight whereas the internal edge and external edge of the flange are radiused to assist in removal of the head from tube 32 and to assist flow into head 102. A well 112 is formed internally within head 102 for axially receiving feed material through the opening in the open top 106. Three regularly spaced apart ports 114 are located circumferentially around the base of well 112 in the region where side wall 104 is joined to base 108. Ports 114 are essentially elongate and extend through side wall 104 at an angle so that fluid can be discharged from the head in a predominantly tangential direction which is a non-radial direction to the outer surface of the side wall 104. The inlets of ports 114 are located in well 112 whereas the outlets of ports 114 are located on the outer surface of head 102. The inlets of ports 114 are arranged to extend tangentially or generally tangentially to the inner wall of well 112 as shown in FIG. 5. Typically, the angle of ports 114 is about 300 and their diameter is about 3.5-3.6 mm. Although three individual ports 114 are shown it is to be noted that any number of ports can be provided depending upon requirements. Typically, the port size of the heads can vary from about 11.0 mm to about 10.0 mm, again depending upon their number and requirements.

A motion modifying element is located around the closed end 108 of head 102. This element modifies the flow of the feed material being discharged through the outlets of outlets 114. This element can take any suitable form to assist in the formation of a swirl motion for the feed material being discharged.

One form of the motion modifying element will now be described.

One form of the motion modifying element is a collar or ring structure 115. Ring structure 115 includes a substantially square profile shoulder 116 that is provided circumferentially around the external surface of the lower edge of head 102. The square shoulder 116 is provided with a flat wall section 118 which in use is substantially parallel to the internal side wall of tube 32 to form a flat sided ring, collar or similar. Flat section 118 assists in evenly and uniformly distributing feed material into tube 32 since the outlets or discharge ports of outlets 114 are located adjacent the upper edge of collar 115. A gap, space, clearance or the like 122 in the form of an annular gap is defined between the collar 115, wall 108, upper flange 116 and the inner wall of tube 32. Further, it is to be noted that there is a clearance between the flat section 118 and the wall of tube 32 as shown in FIG. 6 for allowing the thin film of feed material to form and to helically flow down the upper part of tube 32, by passing between the outer wall of flat section 118 and the inner wall of tube 32 as shown in FIG. 6.

Without wishing to be bound by theory in any way it is thought that feed material being discharged through outlets 114 initially floods the gap, space 122 etc. so as to pressurise feed material in the gap or space 122 which is then forced under pressure between flat surface 118 and wall 32 to flow around shoulder 116 thus forming a swirling movement within tube 32. In use of this form of the head 102, feed material is introduced into head 102 in the direction of arrows ‘A’ of FIG. 6 to flow through the opening of open end 106 and into well 112 where it flows into the inlets of ports 114 and through ports 114 to be discharged externally from the outlets of ports 114 located in the outer surface of head 102 at a location about the top of shoulder 116 in generally a tangential or inclined direction towards the wall of tube 32 thus becoming a swirling motion as shown by arrows ‘B’ of FIG. 6. The swirling motion is formed by a combination of the collar 115 and inner wall of tube 32. The swirling motion includes a flow against the inner wall 32 and around the central core of the evaporator tube. The stream of material exiting from port 114 is fanned into a thin film by a combination of passing between flat section 118 and the wall of tube 32 and by centrifugal forces. The thin film flows in a swirling pattern around the inside of tube 32 initially in a helical flow pattern and then gradually forming into a falling film as it flows further along and down the length of the wall of tube 32 thereby increasing the internal heat transfer caused by the Ranque-Hilsch vortex tube effect in which relatively hotter gases go to the outside of the tube and the relatively cooler gases accumulate in the central core of the tube.

By selecting the velocity at which the feed material is discharged and the sizes of the head 102 and tube 32, and the number, size, position and geometry of discharge ports 114, the residence time of the feed material swirling and flowing in tube 32 can be controlled to achieve optimum separation of desired components in the feed stream, such as by using the heat transferred through the walls of evaporator tube 32.

Further it is to be noted that by imparting controlled velocity and/or acceleration to the feed stream the length of tubes 32 can be made shorter without compromising efficiency thereby effecting a saving in costs, equipment and the like, particularly as the swirling motion of the feed stream exiting the outlets of ports 114 in tube 32 enhances the U value of the heat transference through the walls of the tube.

Also, it is to be noted that the diameter of the tubes can be made smaller, such as for example from about 2″ (50 mm) upwards whilst still allowing the same heat transference. This permits more compact installations containing cyclonic evaporators to be built.

With reference to FIG. 7, it can be seen that there is a linear relationship between the measured flow rate of swirling feed material in each tube measured in litres per hour and the heat transferred through the walls of the tube expressed as U coefficient. This linear relationship shows that the greater the flow rate the greater the U value, at least for the values measured in the test providing the results in FIG. 7. The applicants have no reason to suggest that the linear relationship will not be maintained as the flow rates are increased even higher. The linear relationship between flow rate and U coefficient is expressed by the function

y=6.5355x+395.71 where x is a measure of the flow rate in litres per hour and is the U coefficient corresponding to the particular x value. The correlation coefficient expressed by R² in FIG. 7 has a value of 0.9635. The correlation coefficient is a measure of the accuracy of individual points being exactly located on the line represented by the function of FIG. 7. As can be seen the various actual points plotted on the graph are very close to the line represented by the function.

The effect of the relationship described in FIG. 7 is that the amount of heat being transferred across the evaporator tube walls and into the material flowing through the tube can be increased considerably by increasing the flow rate through the tube using the swirling motion produced by the head of the present invention. This means that cyclonic evaporators employing this type of head are more efficient that similar evaporators not using the head of the present invention. This allows tubes to be made smaller in diameter and shorter in length thereby providing savings in material costs for making the tubes and installing the tubes since less structural support is required for smaller and shorter tubes. Thus, there is a saving in material, manufacturing and installation costs as well as maintenance costs, particularly as the heads are removable for cleaning purposes.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1. A swirl generator comprising an open end located at or towards one end of the generator for receiving fluid therethrough, a side wall portion and a closed end located at or towards another end of the generator, said side wall portion extending between the open end and the closed end, wherein the open end is part of an inlet for admitting fluid into the generator and that at least one outlet is provided in the side wall and/or closed end of the generator for discharging fluid from the generator and tube wall in a swirling motion wherein the generator is provided with a motion modifying element for influencing the flow of material discharged from the outlet.

2. A cyclonic evaporator including a swirl generator and at least one evaporation tube in which fluid admitted to the generator is discharged from the generator to the evaporation tube, the generator comprising an open end located at or towards one end, a closed end located at or towards another end and a side wall portion extending between the open end and the closed end wherein the open end is an inlet for admitting fluid to the generator and at least one outlet is provided in the side wall and/or closed end for discharging fluid from the generator in a swirling motion.

3. A method of treating a fluid having at least two components to at least partially separate the components from each other using a cyclonic evaporator in which fluid admitted to the generator is discharged from the generator in a swirling motion.

4. A swirl generator according to claim 1 in which the motion modifying element is a surface protection or interruption on the outer surface of the head.

5. A swirl generator according to claim 1 in which the motion modifying element is a ring, collar, flange, or the like located at or towards the base of the head.

6. A swirl generator according to claim 1 in which the swirl generator is an inline swirl generator.

7. A swirl generator according to claim 1 in which the swirl generator is a distributor for distributing fluid to more than a single evaporation tube.

8. A swirl generator according to claim 1 in which there is one, two, three, four or more conduits, bores, ports, orifices, appetures, grooves or the like provided in the generator.

9. A generator according to claim 8 in which the conduits etc are straight, spiral, curved, helical or the like and are arranged to extend through the thickness of the wall or end of the generator.

10. A swirl generator according to claim 1 in which that the swirl generator is a substantially or generally tangential flow swirl generator in which at least part of the inlet is arranged to extend axially along the central axis of the generator for receiving incoming feed material and the outlet or outlets are arranged to discharge material tangentially or substantially tangentially to the central axis of the generator.

11. A swirl generator according to claim 1 in which the swirl generator is substantially circular or cylindrical.

12. A swirl generator according to claim 1 in which the outlet or outlets are located at or towards the closed end of the generator and extend from the internal well of the head to discharge feed material from the outside surface of the head.

13. A swirl generator according to claim 1 in which the outlet or outlets are located in the side wall portion of the generator near to or adjacent the closed end.

14. A swirl generator according to claim 1 in which the bore size of the conduit forming the outlet or outlets is from about 0.5 mm to about 10 mm, preferably from about 0.1 mm to 6 mm, more preferably from about 2 mm to 5 mm, even more preferably about 3 mm to 4 mm and most preferably from about 3.5 mm to 3.6 mm.

15. A swirl generator according to claim 1 in which the head is removable from the evaporator tube.

16. A swirl generator according to claim 1 in which the swirl generator is a floating head arrangement which is received in a seat located at or towards the top of the evaporator tube.

17. A swirl generator according to claim 1 in which the swirl generator is rotatable within the seat.

18. A swirl generator according to claim 1 in which the generator can be rotated substantially continuously, intermittently, periodically or randomly.

19. A swirl generator according to claim 1 in which the head can be displaced away from the seat by backwashing, flooding or flushing the tube.

20. A swirl generator according to claim 1 in which movement of the head with respect to the tube provides clearance between the tube and the head to be increased in order to facilitate the cleaning of the tube by allowing cleaning preparation to pass between the head and the tube to dislodge any foreign material that may have accumulated in the region of the head.

21. A swirl generator according to claim 1 in which the generator is an axially moveable or pop up head which can move under the action of a cleaning solution being backwashed or flooded through the tube.

22. A swirl generator according to claim 1 in which the generator is a self cleaning head in which fluid is allowed to drain away from the head through the tube owing to the lose fit of the head in the tube.

23. A swirl generator according to claim 1 in which the head is interchangeable so that a variety of different heads can be interchanged.

24. A swirl generator according to claim 1 in which use of the swirl generator results in improved thermal efficiency of the fluid being swirled axially along the walls of the evaporation tube in a downwards helical flow or similar flow or pattern.

25. A swirl generator according to claim 1 in which use of the swirl generator increases the U factor or U value of the heat transfer of the cyclonic evaporator.

26. A swirl generator according to claim 1 in which the U value is in the range of from about 1,500 to 20,000, preferably up to about 15,000, more preferably in the range of from about 2,000 to 10,000, even more preferably in the range from about 2,500 to 8,000 even more preferably from about 3,000 to 6,000 and most preferably in the range from about 3,000 to 4,000.

27. (Canceled)
